(19) United States
(12) Patent Application Publication
(10) Pub. No.: US 2018/0087920 A1
(43) Pub. Date: Mar. 29, 2018

(54) Travel Assistant Assembly

(71) Applicant: Donald Fegan, Hazlet, NJ (US)

(72) Inventor: Donald Fegan, Hazlet, NJ (US)

(21) Appl. No.: 15/278,121

(22) Filed: Sep. 28, 2016

(51) Int. Cl. G01C 21/36; G06F 17/28

(52) U.S. Cl. CPC G01C 21/3608; G06F 17/289

(57) ABSTRACT

A travel assistant assembly includes a display unit. The display unit may be positioned in a vehicle thereby facilitating the display unit to be visible to a driver. A language unit is coupled to the display unit. The language unit detects spoken words thereby facilitating the language unit to translate the spoken words into a selected language. A speed unit is coupled the display unit. The speed unit detects the speed detection signal thereby facilitating the display unit to emit an audible alarm. A gps unit is coupled to the display unit to determine a physical location of the vehicle. The gps unit displays mapping information with respect to the vehicle.

### CROSS-REFERENCE TO RELATED APPLICATIONS

Not Applicable

### STATEMENT REGARDING FEDERALLY SPONSORED RESEARCH OR DEVELOPMENT Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM. Not Applicable

### STATEMENT REGARDING PRIOR DISCLOSURES BY THE INVENTOR OR JOINT INVENTOR Not Applicable

### BACKGROUND OF THE INVENTION

### (1) Field of the Invention.

### (2) Description of Related Art Including Information Disclosed Under 37 CFR 1.97 and 1.98.

The disclosure and prior art relates to travel devices and more particularly pertains to a new travel device combining a radar detector, gps navigation and language translation.

### BRIEF SUMMARY OF THE INVENTION

An embodiment of the disclosure meets the needs presented above by generally comprising a display unit. The display unit may be positioned in a vehicle thereby facilitating the display unit to be visible to a driver. A language unit is coupled to the display unit. The language unit detects spoken words thereby facilitating the language unit to translate the spoken words into a selected language. A speed unit is coupled the display unit. The speed unit detects the speed detection signal thereby facilitating the display unit to emit an audible alarm. A gps unit is coupled to the display unit to determine a physical location of the vehicle. The gps unit displays mapping information with respect to the vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a travel assistant assembly according to an embodiment of the disclosure.

FIG. 2 is a schematic view of an embodiment of the disclosure.

FIG. 3 is a perspective in-use view of an embodiment of the disclosure.

### DETAILED DESCRIPTION OF THE INVENTION

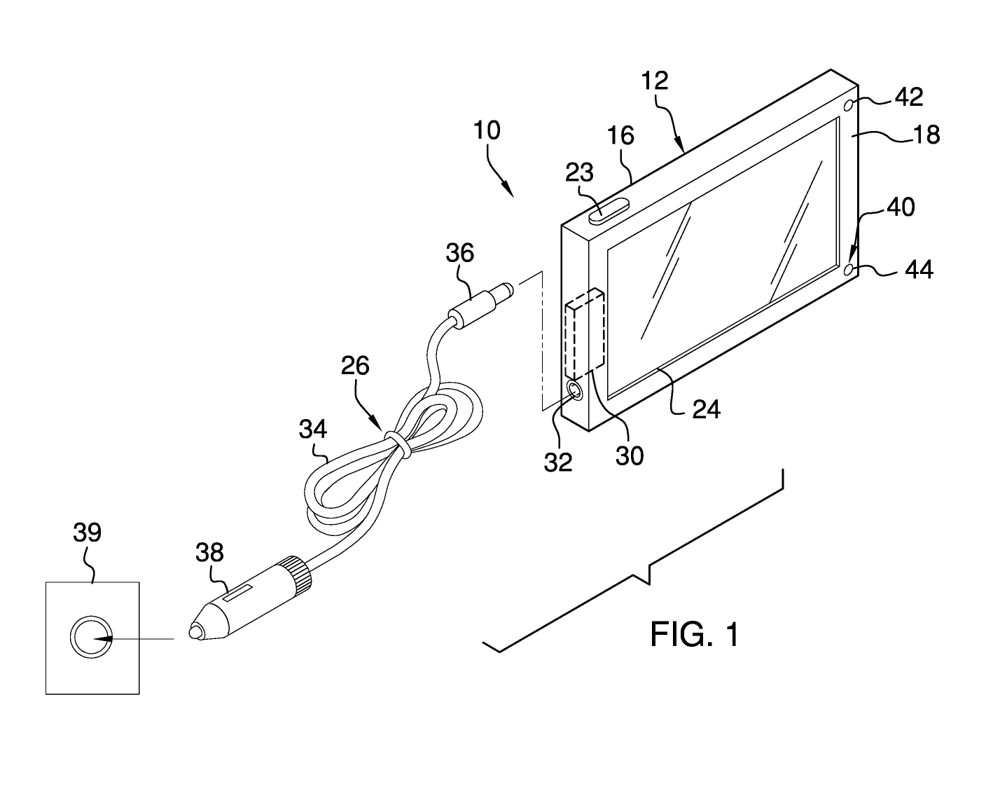

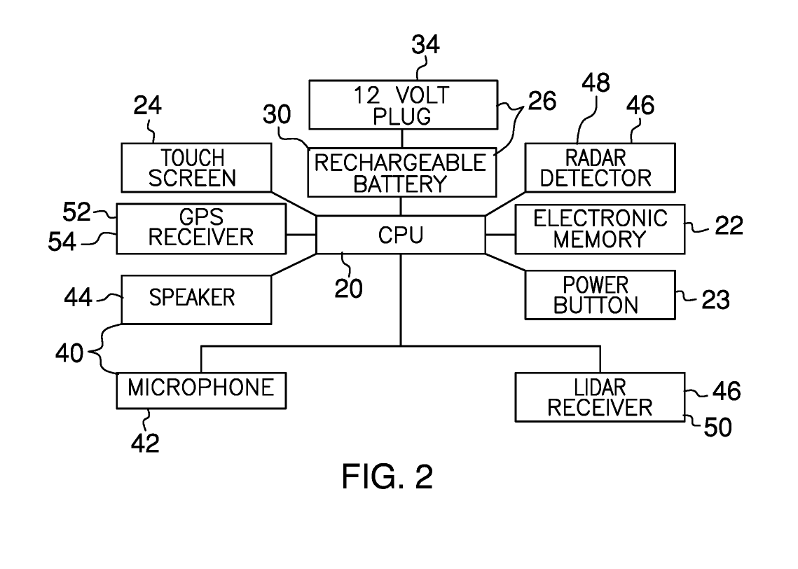

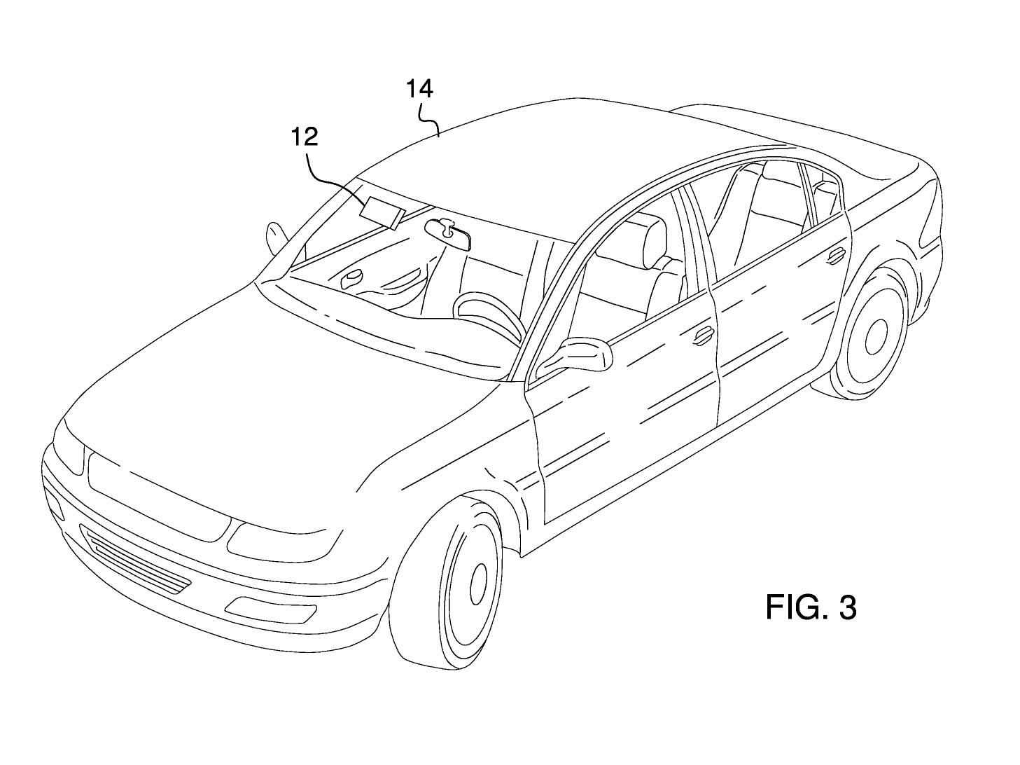

With reference now to the drawings, and in particular to FIGS. 1 through 3 thereof, a new travel device embodying the principles and concepts of an embodiment of the disclosure and generally designated by the reference numeral 10 will be described.

As best illustrated in FIGS. 1 through 3, the travel assistant assembly 10 generally comprises a display unit 12 that may be positioned in a vehicle 14. Thus, the display unit 12 may be visible to a driver. The display unit 12 is electrically coupled to the vehicle 14. The vehicle 14 may be a passenger vehicle 14 or the like.

The display unit 12 comprises a housing 16 that has a front side 18. The housing 16 is coupled to a windshield of the vehicle 14. Thus, the housing 16 may be exposed to a speed detection signal. The speed detection signal may be a Doppler radar signal including, but not being limited to, X band, K, band, Ka band and Ku band radar signals. The housing 16 may be retained on the windshield through any conventional means.

A processor 20 is provided. The processor 20 is positioned within the housing 16. An electronic memory 22 is positioned within the housing 16. The electronic memory 22 is electrically coupled to the processor 20. The electronic memory 22 stores electronic data. Moreover, the electronic data may include language translation software, voice recognition software and gps navigation software. The electronic memory 22 may comprise RAM memory or the like.

A touch screen 24 is provided. The touch screen 24 is coupled to the front side 18 of the housing 16 and the touch screen 24 may be observed. The touch screen 24 is electrically coupled to the processor 20. The touch screen 24 may be a LCD touch screen 24 or the like.

A power supply 26 is coupled to the housing 16. The power supply 26 is electrically coupled to the processor 20. Additionally, the power supply 26 may be electrically coupled to a power source 28. The power source 28 may be a cigarette lighter in the vehicle 14 or the like.

The power supply 26 comprises at least one battery 30. The at least one battery 30 is positioned within the housing 16. The at least one battery 30 is electrically coupled to the processor 20. The at least one battery 30 may be a rechargeable battery.

A charge port 32 is positioned on the housing 16. The charge port 32 is electrically coupled to the at least one battery 30. A charger 34 is provided that has a first plug 36 and a second plug 38. The first plug 36 is selectively electrically coupled to the charge port 32. The second plug 38 is selectively electrically coupled to the power supply 26. Thus, the charger 34 charges the at least one battery 30.

A language unit 40 is provided. The language unit 40 is coupled to the display unit 12. The language unit 40 detects spoken words. Thus, the language unit 40 translates the spoken words into a selected language. Moreover, the language unit 40 recognizes verbal commands with respect to the processor 20.

The language unit 40 comprises a microphone 42. The microphone 42 is coupled to the front side 18 of the housing 16. Thus, the microphone 42 detects spoken words. The microphone 42 is electrically coupled to the processor 20. The processor 20 communicates the spoken words to a translation program on the electronic memory 22. Additionally, the processor 20 communicates the spoken words to the voice recognition software. The voice recognition software controls operational parameters of the processor 20.

A speaker 44 is coupled to the housing 16 and the speaker 44 emits audible sounds. The speaker 44 is electrically coupled to the processor 20. The electronic memory 22 communicates the translated spoken word to the speaker 44. Thus, the speaker 44 emits the translated spoken word. The translated spoken word facilitates verbal communication between the driver and a foreign person. Moreover, the translated spoken words facilitate translation of printed words read aloud by the driver.

A speed unit 46 is provided. The speed unit 46 is coupled the display unit 12. The speed unit 46 detects the speed detection signal. Thus, the display unit 12 emits an audible alarm.

The speed unit 46 comprises a radar receiver 48 that is positioned within the display unit 12. The radar receiver 48 receives the speed detection signal. The radar receiver 48 is electrically coupled to the processor 20. The speaker 44 emits the audible alarm when the radar receiver 48 receives the speed detection signal. Thus, the speaker 44 alerts the driver to the speed detection signal. The radar receiver 48 may be a radio frequency receiver or the like.

The speed unit 46 may further comprise a LIDAR receiver 50. The LIDAR receiver 50 may be electrically coupled to the processor 20. The LIDAR receiver 50 may receive pulsed laser light. The speaker 44 may emit the audible alarm when the LIDAR receiver 50 receives the pulsed laser light.

A gps unit 52 is coupled to the display unit 12. The gps unit 52 determines a physical location of the vehicle 14. Moreover, the gps unit 52 is in communication with a navigation network. Thus, the display unit 12 displays mapping information with respect to the vehicle 14.

The gps unit 52 comprises a global positioning satellite (gps) receiver 54. The gps receiver 54 is positioned within the display unit 12. The gps receiver 54 is electrically coupled to the processor 20. Moreover, the gps receiver 54 is in electrical communication with the navigation network. The gps receiver 54 communicates speed limit data to the processor 20. Thus, the touch screen 24 displays a speed limit of a roadway is on which the vehicle 14 is driving. The speed limit data facilitates the driver to avoid inadvertently exceeding the speed limit.

In use, the housing 16 is positioned in the vehicle 14 and the vehicle 14 is driven. Verbal commands are selectively spoken aloud to control operational parameters of the processor 20. The processor 20 is selectively actuated to translate the spoken words into a selected language for purposes of verbal and written communication. The gps unit 52 determines the physical location of the vehicle 14. Thus, the touch screen 24 selectively displays navigation data to include map and route information. The map and route information are provided in a global context.

Each of the radar receiver 48 and the LIDAR receiver 50 detects the speed detection signal. The speaker 44 emits the audible alarm when the speed detection signal is detected. The speed limit corresponding to the vehicle 14 is displayed on the touch screen 24. Thus, the driver is alerted to drive at the speed limit corresponding to the vehicle 14.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A travel assistant assembly being configured to facilitate language translation, radar detection and mapping, said assembly comprising:
a display unit being configured to be positioned in a vehicle thereby facilitating said display unit to be visible to a driver, said display unit being configured to be electrically coupled to the vehicle, said display unit comprises a housing having a front side, said housing being configured to be coupled to a windshield of the vehicle thereby facilitating said housing to be exposed to a speed detection signal;
a processor being positioned within said housing;
a language unit being coupled to said display unit wherein said language unit is configured to detect spoken words thereby facilitating said language unit to translate the spoken words into a selected language, said language unit including a microphone being coupled to said front side of said housing wherein said microphone is configured to detect spoken words, said microphone being electrically coupled to said processor wherein said processor is configured to communicate the spoken word to a translation program on an electronic memory;
a speaker being coupled to said housing wherein said speaker is configured to emit audible sounds, said speaker being electrically coupled to said processor wherein said electronic memory is configured to communicate the translated spoken word to said speaker;
a speed unit being coupled said display unit wherein said speed unit is configured to detect a speed detection signal thereby facilitating said display unit to emit an audible alarm; and
a gps unit being coupled to said display unit wherein said gps unit is configured to determine a physical location of the vehicle, said gps unit being configured to be in communication with a navigation network thereby facilitating said display unit to display mapping information with respect to the vehicle.

2. (canceled)

3. (canceled)

4. The assembly according to claim 1, further comprising an electronic memory being positioned within said housing, said electronic memory being electrically coupled to said processor, said electronic memory being configured to store electronic data.

5. The assembly according to claim 1, further comprising a touch screen being coupled to said front side wherein said touch screen is configured to be observed, said touch screen being electrically coupled to said processor.

6. The assembly according to claim 1, further comprising a power supply being coupled to said housing, said power supply being electrically coupled to said processor, said power supply being configured to be electrically coupled to a power source.

7. The assembly according to claim 6, wherein said power supply comprises:
at least one battery being positioned within said housing, said at least one battery being electrically coupled to said processor
a charge port being positioned on said housing, said charge port being electrically coupled to said at least one battery, and
a charger having a first plug and a second plug, said first plug being selectively electrically coupled to said charge port, said second plug being configured to be electrically coupled to the power supply, said charger charging said at least one battery.

8. (canceled)

9. (canceled)

10. The assembly according to claim 1, wherein said speed unit comprising a radar receiver being positioned within said display unit wherein said radar receiver is configured to receive the speed detection signal, said radar receiver being electrically coupled to said processor.

11. The assembly according to claim 10, further comprising a speaker, said speaker emitting said audible alarm when said radar receiver receives the speed detection signal wherein said speaker is configured to alert the driver to the speed detection signal.

12. The assembly according to claim 1, wherein said gps unit comprises a global positioning satellite (gps) receiver being positioned within said display unit, said gps receiver being electrically coupled to said processor, said gps receiver being configured to be in electrical communication with the navigation network, said gps receiver being configured to communicate speed limit data to said processor thereby facilitating said touch screen to display a speed limit of a roadway being on which the vehicle is driving.

13. A travel assistant assembly being configured to facilitate language translation, radar detection and mapping, said assembly comprising:
a display unit being configured to be positioned in a vehicle thereby facilitating said display unit to be visible to a driver, said display unit being configured to be electrically coupled to the vehicle, said display unit comprising:
a housing having a front side, said housing being configured to be coupled to a windshield of the vehicle thereby facilitating said housing to be exposed to a speed detection signal,
a processor being positioned within said housing,
an electronic memory being positioned within said housing, said electronic memory being electrically coupled to said processor, said electronic memory being configured to store electronic data,
a touch screen being coupled to said front side wherein said touch screen is configured to be observed, said touch screen being electrically coupled to said processor, and
a power supply being coupled to said housing, said power supply being electrically coupled to said processor, said power supply being configured to be electrically coupled to a power source, said power supply comprising:
at least one battery being positioned within said housing, said at least one battery being electrically coupled to said processor
a charge port being positioned on said housing, said charge port being electrically coupled to said at least one battery, and
a charger having a first plug and a second plug, said first plug being selectively electrically coupled to said charge port, said second plug being configured to be electrically coupled to the power supply, said charger charging said at least one battery;
a language unit being coupled to said display unit wherein said language unit is configured to detect spoken words thereby facilitating said language unit to translate the spoken words into a selected language, said language unit comprising:
a microphone being coupled to said front side of said housing wherein said microphone is configured to detect spoken words, said microphone being electrically coupled to said processor wherein said processor is configured to communicate the spoken word to a translation program on said electronic memory, and
a speaker being coupled to said housing wherein said speaker is configured to emit audible sounds, said speaker being electrically coupled to said processor wherein said electronic memory is configured to communicate the translated spoken word to said speaker;
a speed unit being coupled said display unit wherein said speed unit is configured to detect a speed detection signal thereby facilitating said display unit to emit an audible alarm, said speed unit comprising a radar receiver being positioned within said display unit wherein said radar receiver is configured to receive the speed detection signal, said radar receiver being electrically coupled to said processor, said speaker emitting said audible alarm when said radar receiver receives the speed detection signal wherein said speaker is configured to alert the driver to the speed detection signal; and
a gps unit being coupled to said display unit wherein said gps unit is configured to determine a physical location of the vehicle, said gps unit being configured to be in communication with a navigation network thereby facilitating said display unit to display mapping information with respect to the vehicle, said gps unit comprising a global positioning satellite (gps) receiver being positioned within said display unit, said gps receiver being electrically coupled to said processor, said gps receiver being configured to be in electrical communication with the navigation network, said gps receiver being configured to communicate speed limit data to said processor thereby facilitating said touch screen to display a speed limit of a roadway being on which the vehicle is driving.
